(19) United States
(12) Patent Application Publication
(10) Pub. No.: US 2019/0082729 A1
(43) Pub. Date: Mar. 21, 2019

(54) Device and Method for Automated Seasoning of Food Items

(71) Applicant: Ivan A. Whitaker, Covington, GA (US)

(72) Inventor: Ivan A. Whitaker, Covington, GA (US)

(21) Appl. No.: 15/709,573

(22) Filed: Sep. 20, 2017

(51) Int. Cl. A23P 20/10; A23L 27/00

(52) U.S. Cl. CPC A23P 20/10; A23V 2002/00; A23L 27/00

(57) ABSTRACT

The inventive concept is a culinary appliance, being a separable globe having an upper bowl and a lower bowl. The upper bowl fits securely over the lower bowl, whereby at lease one item of food with seasonings or other substances can be placed within the closed globe. A variety of accessories may be attached to a shaft connected interiorly to the globe along a particular diametric axis of the globe. Operation of the appliance is accomplished by use of a hand crank or an electric motor attachment, either of which may be connected to one protruding end of the shaft. Rotation of the shaft, in conjunction with an accessory, will cause food items placed in the globe to be gently turned over and around such that the food items will be coated evenly with desired seasonings or other substances.

### CROSS-REFERENCES TO RELATED APPLICATIONS

None

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The inventive concept disclosed relates to an apparatus and method for turning and exposing, in a closed container, one or several portions of a food item for the purpose of ensuring the even and consistent application of various selectable types of seasonings, condiments, flavorings, or other useful additives to the item of food. The method and device relates to an improved spherical-shaped mechanical or motorized tumbler which may also be operated with a number of internal accessories or agitators to enhance the uniform application of the seasonings, flavorings, or other desired additives.

### (2) Description of the Related Art, including information disclosed under 37 CFR 1.97 and 1.98

U.S. Pat. No. 1,840,289 (Jan. 5, 1932). A coating apparatus, being a horizontally rotating drum comprising two co-axial counter-coned shells, one within the other and separated by a circumferential interspace, said inner shell being wholly reticulate and equipped with long-pitched spiral vanes to enure positive forward gravitational progression of articles to be coated introduced at the small or intake end toward the larger or discharge end, the outer shell being imperforate and merging into the inner shell at the delivery end of the apparatus, and said outer shell serving to induce rearward gravitation of excess coating material released from the articles incidental to progression through the apparatus into the interspace aforesaid for re-use at the intake end of the drum.

U.S. Pat. No. 6,619,226 (Sep. 16, 2003). The seasoning applicator applies seasoning onto snack food products such as potato chips, corn chips, tortilla chips, and the like in a two-dimensional seasoning pattern. A two compartment sifting assembly has a first top layer having a screen where seasoning is initially deposited. Upon vibration, the seasoning is passed through fee top layer screen into a lower compartment. Therein, the seasoning is further distributed across the surface of the lower layer screen, which generally has a screen with smaller openings than the top layer screen. This promotes the even distribution of seasoning through the lower screen. Thereby, a two-dimensional seasoning pattern is created for depositing on a moving bed of snack food products.

U.S. Pat. No. 9,044,048 (Jun. 2, 2015) Systems and methods for applying seasoning or flavoring to food items or products, for example, taco shells, are provided. A seasoning system can include a seasoning hopper or other storage container, a scarf plate, a scalping screen, a conveyor system, and a collection bin. The scalping screen can help reduce clumps in seasoning that falls onto the food items to allow for more even and consistent seasoning distribution. The conveyor system can include a mechanism for tilting or pivoting the food items to allow for application of seasonings to multiple surfaces of the food item as the food items are conveyed under the seasoning delivery system. A method for applying seasoning to food items can include adjusting process parameters such as presentation angle of the food items, throughput, seasoning flow rate, etc. to adapt to varying conditions such as temperature, humidity, and seasoning coverage.

U.S. Pat. No. 9,609,891 (Apr. 4, 2017). An apparatus to apply seasoning to a foodstuff comprising a plurality of individual food portions comprises a rotatable drum supportable in a generally horizontal position and having an inlet at a first end, an outlet at a second end and a bore extending through the drum from the inlet to the outlet, with a substantial portion of the bore having a generally frustoconical interior with a larger diameter end of the frustoconical interior disposed proximal to the inlet and a smaller diameter end of the frustoconical interior portion disposed proximal to the outlet. In one embodiment, the frustoconical interior portion extends substantially from the inlet to the outlet and converges in that direction. In another embodiment, the generally frustoconical portion extends from a generally cylindrical interior portion, that is intermediate the inlet and the frustoconical interior portion, to the outlet and converges in that direction.

### BRIEF SUMMARY OF THE INVENTION

The inventive concept referred to out of convenience as the “Kitchen Globe,” (the “Globe” 1) has two detachable main parts, an upper bowl 2, and a bottom section, or lower bowl 3. The lower bowl 3 is designed similar to a large mixing bowl used frequently for everyday food preparation. Different mixers, attachments, or paddles can be attached in the center openings of the Globe 1 after the food item(s) has been placed in the lower bowl 3. The upper bowl 2 fits securely over the lower bowl 3 and seasonings or other substances can be dropped in through a small door 6 in the upper bowl 2.

Manual operation of the Globe 1 is accomplished by use of a hand crank 45 which is constructed with a crankshaft 48 having a fitting adapted to accept one end of a shaft 52, the shaft of a length encompassing the longest horizontal diameter of the Globe 1. The Globe 1 may be electrically operated, after the insertion of a desired accessory, by inserting an end of the shaft 52 into a specially-fitted receptacle 64 on an electric motor 60.

The Globe 1, when operated as designed, accepts any one of a selection of detachable accessories which may be affixed to both ends of the shaft 52. Insertion of a selected accessory and rotation of the shaft 52 will cause food items placed in the Globe 1 to be gently turned within the confines of the upper and lower bowls 2, 3. Thus, the desired result is that the food items will be coated evenly with desired seasonings or other substances. Different accessories are available for the Globe 1 and may be used as necessary, thus making this device extremely versatile.

### BRIEF DESCRIPTION OF THE VIEWS OF EXEMPLARY EMBODIMENTS, PRESENTED IN THE FORM OF DRAWINGS

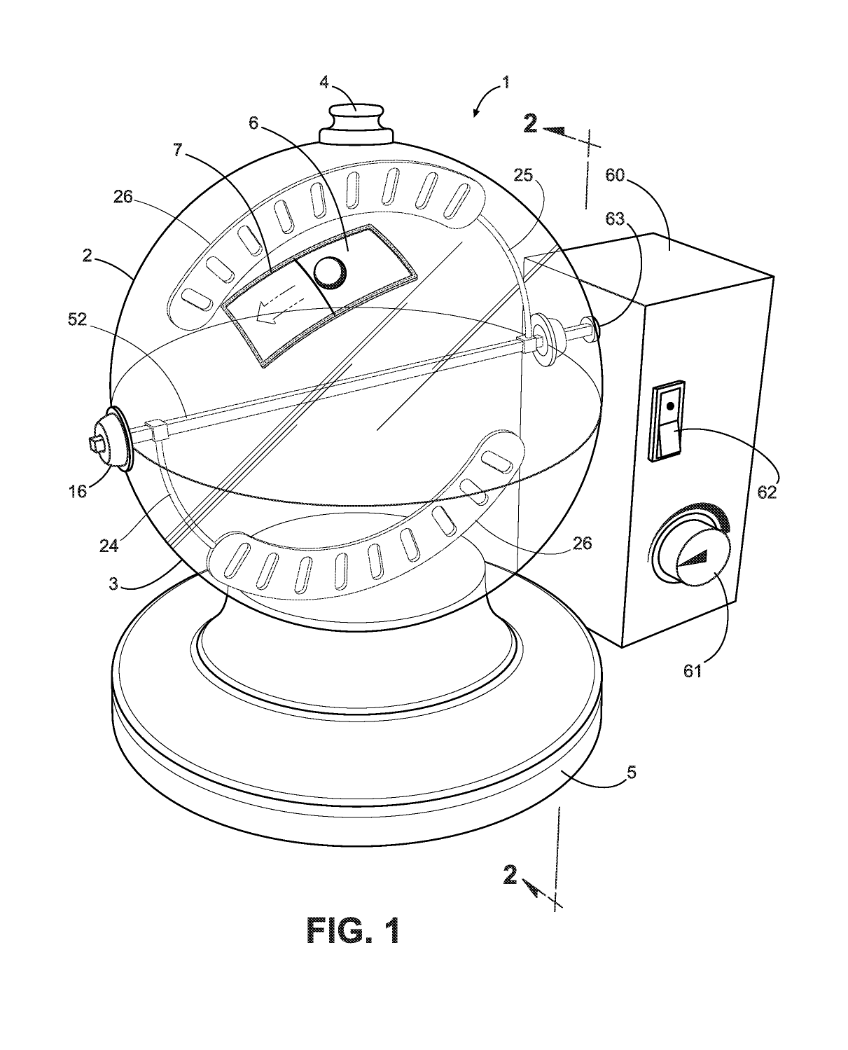

FIG. 1 is a perspective view of the Kitchen Globe 1, further showing an electric motor 60 having a drive fitting 63 corresponding to the shaft 52.

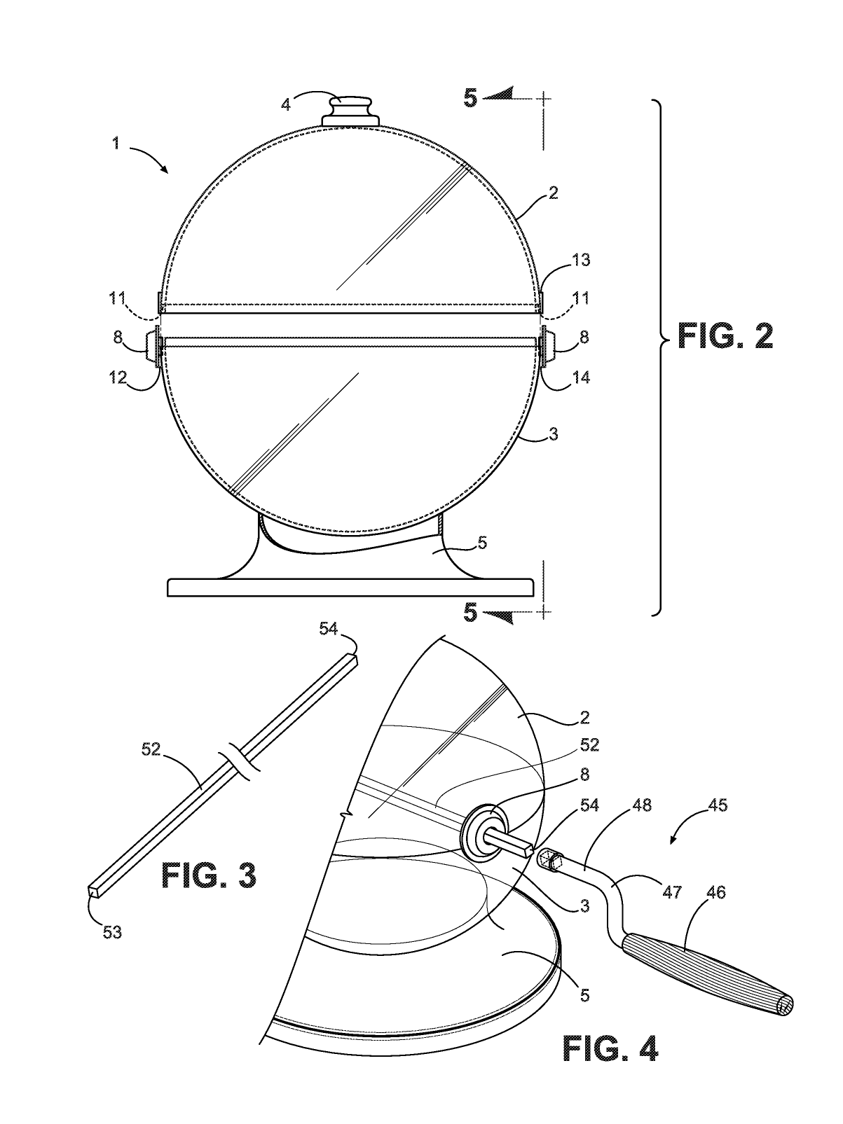

FIG. 2 is a sectional view of the separable upper bowl 2 and lower bowl 3, as seen from the orientation of section line 2-2 of FIG. 1.

FIG. 3 is a perspective view of the shaft 52.

FIG. 4 is a view of the crank 45 used to manually operate the Globe 1, when connected to the right end 54 of the shaft 52.

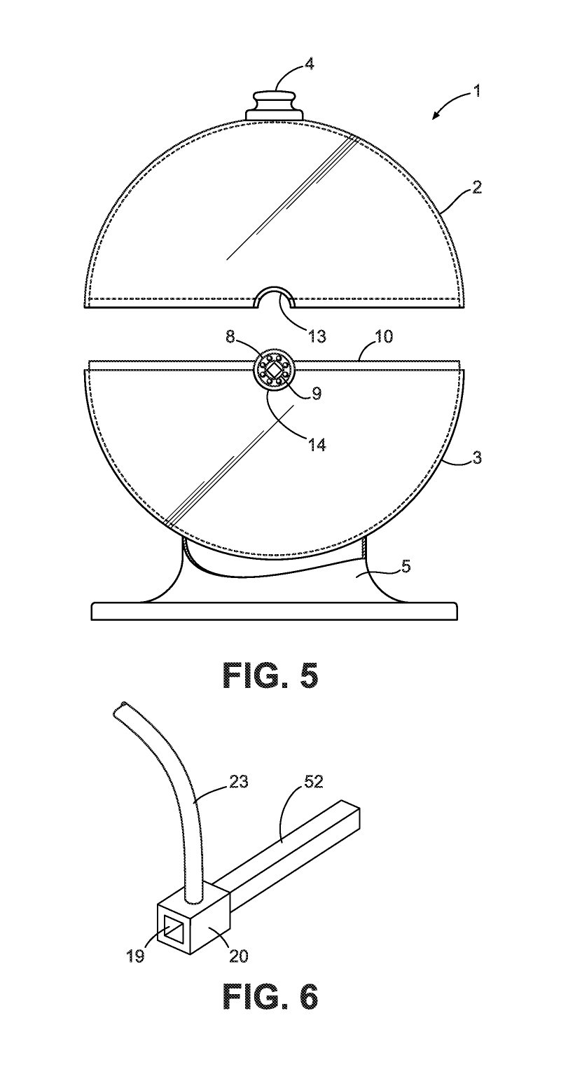

FIG. 5 presents a sectional view of the Globe 1 as seen from the perspective of section line 5-5 of FIG. 2, and further illustrating the roller bearing 8 assembly

FIG. 6 depicts the box fitting 20 which is integral to the connecting rods 23 of several accessories of the Globe 1.

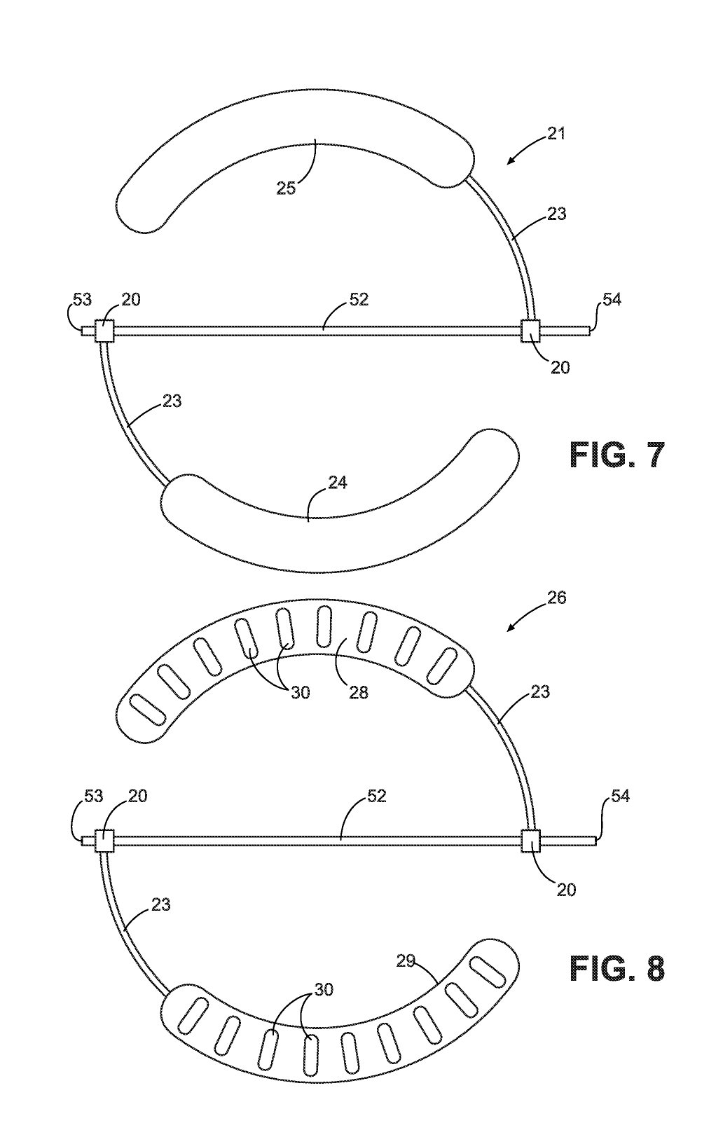

FIG. 7 shows the two matching arms 24, 25 of the paddle 21 accessory, each of which may be attached to opposite ends of the shaft 52 by means of a box fitting 20.

FIG. 8 illustrates the two matching arms 28,29 of the drain paddle 26 accessory, each of which may be attached to opposite ends of the shaft 52 by means of the box fitting 20.

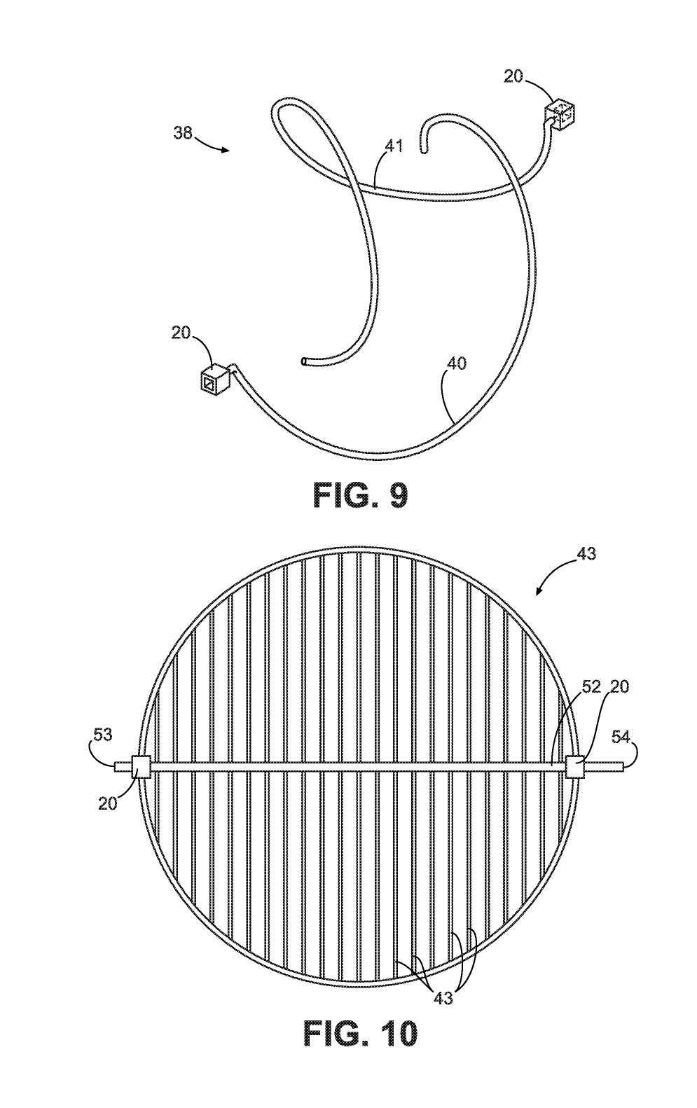

FIG. 9 depicts the two matching beater coils 40, 41 of the mixer 38 accessory, each coil of which is attached, by means of the integral box fittings 20, to opposite ends of the shaft 52.

FIG. 10 depicts the grate 42 accessory as attached to both ends of the shaft 52 by means of box fittings 20.

Table of Nomenclature & Part Numbers of Invention

| | |
|---|---|
| 1. | Kitchen Globe |
| 2. | Upper bowl |
| 3. | Lower bowl |
| 4. | Top handle |
| 5. | Base |
| 6. | Slide door |
| 7. | n/a |
| 8. | Roller bearing |
| 9. | Bearing fitting |
| 10. | Interior rim |
| 11. | Left upper arc |
| 12. | Left lower arc |
| 13. | Right upper arc |
| 14. | Right lower arc |
| 15. | Left collar |
| 16. | Right collar |
| 17. | T/B/D |
| 18. | Left socket |
| 19. | Right socket |
| 20. | Box fitting |
| 21. | Paddle |
| 22. | n/a |
| 23. | Rod |
| 24. | Left arm |
| 25. | Right arm |
| 26. | Drain paddle |
| 27. | n/a |
| 28. | First arm |
| 29. | Second arm |
| 30. | Opening |
| 31. | Shaft Drain arm |
| 32.-37. | n/a |
| 33. | Mixer |
| 39. | n/a |
| 40. | Left coil |
| 41. | Right coil |
| 42. | Grate |
| 43. | Grate rods |
| 44. | Grate ring |
| 45. | Crank |
| 46. | Crank handle |
| 47. | Crank elbow |
| 48. | Crankshaft |
| 49. | Crank fitting |
| 50.-51. | n/a |
| 52. | Shaft |
| 53. | Shaft left end |
| 54. | Shaft right end |
| 55.-59. | n/a |
| 60. | Motor |
| 61. | Speed control knob |
| 62. | Switch |
| 63. | Shaft receptor |

### DETAILED DESCRIPTION OF THE INVENTION

The objects, features, and advantages of the inventive concept presented in this application are more readily understood when referring to the accompanying drawings. The drawings, totaling ten figures, show the basic components and functions of embodiments and/or methods of use. In the several figures, like reference numbers are used in each figure to correspond to the same component as may be depicted in other figures.

The discussion of the present inventive concept will be initiated with FIG. 1, which illustrates a “see-through” perspective view of the Kitchen Globe 1 (hereinafter, “Globe” 1). The Globe 1 comprises an upper bowl 2 and a lower bowl 3 which constitute upper and lower hemispheres of the Globe 1. The lower bowl 3 is attached to a base 5. A top handle 4 is attached to the upper bowl 2 for the convenience of a user of the Globe 1. The upper bowl 2 and lower bowl 3 can be mechanically separated from, and re-attached to each other by a variety of connecting mechanisms, including form-fitting circular tracks, snaps, and other means.

The embodiment shown in FIG. 1 depicts the Globe 1 equipped with a specific detachable accessory referred to as a “drain paddle” 26. The drain paddle 26 has a left arm 24 and right arm 25, each attached to a shaft 52. In FIG. 1, the shaft 52 is turned by means of a connection to an electric motor 60. An on-off switch 62 routes electrical power to the motor and a speed control knob 61 is used for selecting the rotation rate of the shaft 52. A shaft receptor 63 comprises an opening compatible with the cross-sectional contour of the shaft 52, and further, the shaft receptor 63 is affixed to a rotatable drive mechanism within the motor 60.

As will be shown later, a mechanical crank 45 may be attached to one end of the shaft 52 for manually turning the shaft 52 during preparation of food items placed inside the Globe 1.

Further shown in FIG. 1 is a slide door 6 which is openable for the purpose of placing necessary or additional seasonings or other substances inside the Globe 1. The door 6 may be operated by sliding along a custom-formed track within the surface of the upper bowl 2. Different embodiments provide for operation of the door 6 by other means, including hinges, snaps, or a rotatable connector. A left collar 15 and right collar 16 serve as housings for left and right roller bearing 8 assemblies (not shown) which provide the rotational mechanism for the each respective end of the shaft 52.

FIG. 2 is a sectional view of the separated upper bowl 2 and lower bowl 3, as seen from the orientation of section line 2-2 of FIG. 1. A left upper arc 11 and a right upper arc 13 are constructed on the outer surface of the upper bowl 2 to accommodate the upper portions of the left collar 15 right collar 16, respectively. Similarly, a left lower arc 12 and right lower arc 14 are constructed on the outer surface of the lower bowl 3 to accommodate the lower portions of the left collar 15 and right collar 16, respectively. The shaft 52 is shown extended across the diameter of the lower bowl 3, having been inserted within the roller bearings 8 on both sides of the Globe 1.

FIG. 3 is a view of the shaft 52, further showing the left end 53 and the right end 54 of the shaft 52. The shaft 52 has a square cross-section, which facilitates attachment of the various accessories that may be used with the Globe 1. FIG. 4 is a perspective view of the manual crank 45 which may be utilized for manually rotating the shaft 52 of the Globe 1. The open end of the crankshaft 48 has a recessed square opening of dimensions corresponding to the cross-section of the right end 54 of the shaft 52. In this manner, the crank 45 is attachable to the shaft 52. An elbow 47 leads from the crankshaft 48 to a crank handle 46. The handle 46 may then be grasped by a user to rotate the entirety of the shaft 52.

Turning to FIG. 5, there is depicted a sectional view of the Globe 1 having detached the upper bowl 2 and lower bowl 3, as seen from the orientation of section line 5-5 of FIG. 2. The right upper arc 13 of the upper bowl 2 and right lower arc 14 of the lower bowl 3 are shown. An interior rim 10, integral to the lower bowl 3 is constructed so as to facilitate various connecting mechanisms to join the upper and lower bowls 2, 3. The right collar 16 is not depicted in FIG. 5 so as to illustrate a sectionalized view of the right roller bearing 8 assembly, as shown. Centered within the roller bearing 8 is a square-shaped bearing fitting 9 which is used to accommodate one end of the shaft 52.

FIG. 6 presents a close-up view of a box fitting 20, which is typically used as an integral component of accessories used in the Globe 1. In the preferred embodiments, all accessories used in the Globe 1 are constructed with two box fittings 20 for connection proximate each end of the shaft 52. FIG. 6 specifically depicts one end of the rod 25 which is integral to the drain paddle 26 accessory shown in FIG. 1. The box fitting is constructed with a socket 19 comprising a square opening which approximately corresponds to the square cross-section of the shaft 52 used in the Globe 1.

FIG. 7 shows the left arm 24 and right arm 25 of a paddle 21 accessory. Each arm 24, 25 is shown as securely attached to opposite ends 53, 54 of the shaft 52 by means of the box fitting 20 previously described. The paddle 21 accessory is used to turn and rotate food items within the Globe 1.

FIG. 8 shows the first arm 28 and second arm 29 of a drain paddle 26 accessory. Each arm 28, 29 is shown as securely attached to opposite ends 53, 54 of the shaft 52 by means of the box fitting 20 previously described. The drain paddle 26 accessory is used to turn and rotate food items within the Globe 1, and simultaneously permit the flow of liquids that may be present, through several openings 30 in each arm 28, 29.

FIG. 9 illustrates a left coil 40 and right coil 41 of a mixer 38 accessory. Each coil 40, 41 may be securely attached to opposite ends 53, 54 of the shaft 52 by means of the box fittings 20 depicted. The paddle 21 accessory is used to turn and rotate food items, condiments, and/or other substances placed inside the Globe 1.

A device similar to the mixer 38 accessory would comprise a plurality of coils 40, 41 attached around the periphery of a solid, elliptical-shaped structure, entitled a “kneader,” (not shown in the drawings) for the purpose of kneading food items and/or seasonings within the Globe 1. The kneader would also have box fittings 20 for affixing to the ends of the shaft 52.

FIG. 10 depicts a grate 42 accessory as attached to both ends of the shaft 52 by means of two box fittings 20. The grate 42 accessory is shown comprising a plurality of grate rods 43, constrained to a circumferential grate ring 44. The grate 42 serves to support and rotate larger-sized food items that may be placed within the Globe 1 for purposes of mixing with seasonings or other substances.

As has been demonstrated, the inventive concept is versatile and may be used with additional accessories, other than those specifically shown in the exemplary pictorial embodiments. Such additional accessories, by way of illustration, and not limitation, can include kneaders, razor edges, spiked implements, corkscrews, threaded implements, whisks, and wire-wound implements.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. Where it is desired to uniformly apply seasonings or any type of substances onto the surface of at least one item of food within a closed container, an apparatus is provided to perform such task, the apparatus comprising:
(a) an openable, hollow globe containing interior space for the placement of said at least one item of food along with selected seasonings and/or substances; and
(b) a means of continuously displacing and/or rotating said item of food when it is positioned inside the closed globe in containment with the selected seasonings and/or substance.

2. The apparatus of claim 1, wherein the means of displacing the at least one item of food comprises an accessory implement having a means of interiorly connecting to opposite ends of the implement to a particular axis of the globe, and further, a means of rotating the accessory implement about said particular axis of the globe.

3. The apparatus of claim 1, wherein the means of displacing the at least one item of food comprises an accessory implement connectable to a shaft, said shaft being of length equal to at least the diameter of the globe, and further, a means of (a) connecting the ends of the shah interiorly to the globe along a particular axis of said globe and (b) a means of rotating the shaft about the particular diametric axis of the globe.

4. The apparatus of claim 1, wherein the means of displacing the at least one item of food comprises an accessory implement connectable to a shaft of rectangular cross section, the shaft being of length equal to at least the diameter of the globe, and further, the shaft having endmost box fittings with an interior corresponding to the cross-section of the shaft and further, identical left and right roller bearing assemblies affixed to opposing poles of the globe, each roller bearing having an internal fitting corresponding to, and acceptable of insertion of the respective ends of the shaft, wherein the left or the right roller bearing may then be turned by a manual crankshaft, thereby turning the accessory implement.

5. The apparatus of claim 1, wherein the means of displacing the at least one item of food comprises an accessory implement correctable to a shaft of rectangular cross section, the shaft being of length equal to at least the diameter of the globe, and further, the shaft having endmost box fittings with an interior corresponding to the cross-section of the shaft and further, identical left and right roller bearing assemblies affixed to opposing poles of the globe, each roller bearing having an internal fitting corresponding to, and acceptable of insertion of the respective ends of the shaft, wherein the left or the right roller bearing may then be turned by an electric motor, thereby turning the accessory implement.

6. Where it is desired to uniformly apply seasonings, condiments, or other substances onto the surface of at least one item of food with in a closed container, a closeable apparatus for performing such task is provided, comprising:
a globe connectedly separable into a top hemisphere section and a bottom hemisphere;
a shaft having a uniform cross-section and of length at least equal to the diameter of said globe;
a connector fixed at each of end of an axis defining diametrically opposed sides of the closed globe, each connector being rotatable about the axis and each connector having a recessed fitting of dimensions compatible with the cross-section of said shaft;
at least one accessory implement attachable to the shaft and of dimensions containable within the interior of said globe; and
a means of rotating said connectors with at least one accessory implement attached to the shaft and each respective end of the shaft inserted into the diametrically opposed connectors.

7. The closeable apparatus of claim 6, wherein the connector comprises a left and a right roller bearing assembly , each affixed to opposing poles of the globe, each roller bearing assembly having an internal fitting corresponding to, and acceptable of insertion of the respective ends of the shaft, wherein the left or the right roller bearing may then be turned by a corresponding hand crank, thereby turning the accessory implement.

8. The closeable apparatus of claim 6, wherein the connector comprises a left and a right roller bearing assembly, each affixed to opposing poles of the globe, each roller bearing assembly having an internal fitting corresponding to, and acceptable of insertion of the respective ends of the shaft, wherein the left or the right roller bearing may then be turned by an electric motor, thereby turning the accessory implement.

9. The closeable apparatus of claim 6 wherein the at least one accessory Implement is selected from the group consisting of (a) a dual-component paddle having a left arm and a right arm, b) a dual-component drain paddle having a first arm and a second arm, (c) a dual-component curvilinear mixer having a left coil and a right coil, (d) a grate having a plurality of parallel grate rods attached to a closed ring, and (e) an elliptically-shaped kneader having a plurality of coils wrapped about its exterior.

10. Where it is desired to uniformly apply seasonings, condiments, or other substances onto the surface of at least one item of food within a closed container, a method for performing such task is disclosed, the method comprising the steps of:
providing a hollow globe which is separable into an upper bowl and a lower bowl;
providing a shaft having a square cross-section and of length at least equal to the diameter of said globe;
providing two roller bearing assemblies each affixed at diametrically opposed poles of the closed globe, each roller bearing assembly being rotatable about a specific axis of the globe, and each roller bearing assembly having a recessed fitting of dimensions compatible with insertion of the cross-section of either end of the shaft;
providing an accessory implement attachable to the shaft and having dimensions containable within the interior of said globe;
connecting the accessory implement onto the shaft;
inserting the opposite ends of the shaft within the respective roller bearing assemblies;
placing said at least one item of food, including desired seasonings or other substances within the globe;
connecting the upper and lower bowls of the globe; and
rotating the shaft about its axis.

11. An apparatus as in claim 10, where the means of rotating the shaft about its axis comprises a hand crank connectible to a protruding end of the shaft.

12. An apparatus as in claim 10, wherein the means of rotating the shaft about its axis comprises an electric motor having a shaft receptor connectible to a protruding end of the shaft.

13. The method of claim 10, wherein the at least one accessory implement is selected from the group consisting of (a) a dual-component paddle having a left arm and a right arm, b) a dual-component drain paddle having a first arm and a second arm, (c) a dual-component curvilinear mixer having a left coil and a right coil, (d) a grate having a plurality of parallel grate rods attached to a closed ring, and (e) an elliptically-shaped kneader having a plurality of coils wrapped about its exterior.
